(19) United States
(12) Patent Application Publication
(10) Pub. No.: US 2005/0223684 A1
(43) Pub. Date: Oct. 13, 2005

(54) Horse driving harness

(76) Inventor: Pauli Gronberg, Tuusula (FI)

Correspondence Address: KUBOVCIK & KUBOVCIK, SUITE 710, 900 17TH STREET NW, WASHINGTON, DC, 20006, US

(21) Appl. No.: 11/103,429

(22) Filed: Apr. 12, 2005

(30) Foreign Application Priority Data
Apr. 13, 2004 (EP) 04076105.8

(51) Int. Cl. B68C 1/02

(52) U.S. Cl. 54/39.1

(57) ABSTRACT

A horse driving harness (1) for attaching a pullable implement such as a sulky is disclosed, the harness being mountable on a horse's back and securable thereto with the help of straps (2) and the driving harness incorporating a hitch device (5) adapted on the sides of the harness facing both flanks of the horse for hitching the sulky shafts to the harness. According to the invention, the mounting of the hitch device (5) to the harness (1) is implemented with the help of a ball joint, whereby the hitch device is freely rotatable relative to the harness within the constraints of the ball joint.

The present invention relates to a horse driving harness for attaching a pullable implement such as a sulky, the harness being mountable on a horse's back and securable thereto with the help of suitable straps, the driving harness incorporating a hitch device adapted on the sides of the harness facing both flanks of the horse for hitching the sulky shafts to the harness.

Hitching a sulky or other like pullable attachments to the horse's equipment is carried out with the help of so-called harnesses that are mounted on the horse's back and secured by straps or bands passed below the horse's chest/breast. To both sides of the harness, on the surfaces facing the horse's flanks, is mounted a hitch device suitable for connection to a sulky or the like two-shaft implement/vehicle. Today, hitching is generally implemented using so-called quick hitches that permit rapid attachment of compatible vehicle connection members thereto.

The hitch devices are typically attached to the harness by straps passed through openings made to the hitch devices. Generally, the straps are quite stiff. Resultingly, during running (e.g., when pulling a sully) the horse must from time to time turn aside, whereby the stiff straps hardly yield thus causing the turning movement to rotate the harness, whose edge thereby is pressed against the horse's flank in a painful fashion to the horse. Another drawback resulting from the stiff hitching technique is that the horse is hindered from turning freely. The horse must turn in a forced fashion, because the joint at the hitch device is of an unyielding type. A still further drawback in the conventional method of attaching the hitch device is that at a turning movement of the horse a frictional motion occurs between the hitch device and its straps, whereupon the straps at the point of the hitch device rapidly wear into a fully degraded condition.

It is an object of the present invention to provide a horse driving harness having its shaft hitch device realized in a fashion capable of overcoming the above-described drawbacks. The harness according to the invention is characterized in that the attachment of the hitch device on the harness is implemented by virtue of a ball joint, whereby the hitch device is freely rotatable relative to the harness within the constraints of the ball joint.

A preferred embodiment of the harness according to the invention is characterized in that to the harness is attached a mounting plate having its interior surface formed into a semi-hemispherical cavity, wherein is adapted a ball end of an essentially compatible spherical shape machined or attached to one end of the mounting pin of the hitch device.

Another preferred embodiment of the harness according to the invention is characterized in that about the mounting pin of the hitch device is adapted a coiled spring extending from the hitch device to the mounting plate so as to stiffeningly pretension the ball joint.

A still another preferred embodiment of the harness according to the invention is characterized in that the straps are attached in a buried fashion in the interior of the harness body so that the underside surface of said strap and the underside surface of the harness body are aligned substantially in the same plane.

The ball joints in the hitch devices according to the invention allow the horse to turn more freely relative to the sulky shafts, whereby the trot or gait of the horse is easier. The unhindered swivel capability of the hitch devices also assures that the harness itself will not rotate nor cause pain or other disturbance during the motion of the horse. A further advantage offered by the invention is the omission of all straps from the hitch device, whereby the wear problems of straps are eliminated. As a result, the hitching method according to the invention is extremely wear-resistant and durable in use.

In the following, the invention is described in more detail by making reference to appended drawings, in which

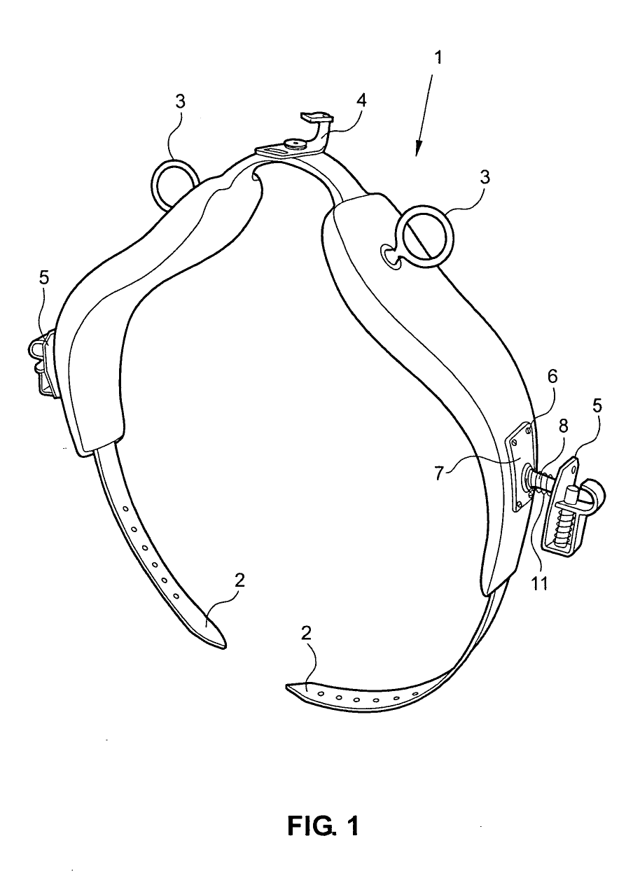

FIG. 1 is an axonometric view of a driving harness according to the invention; and

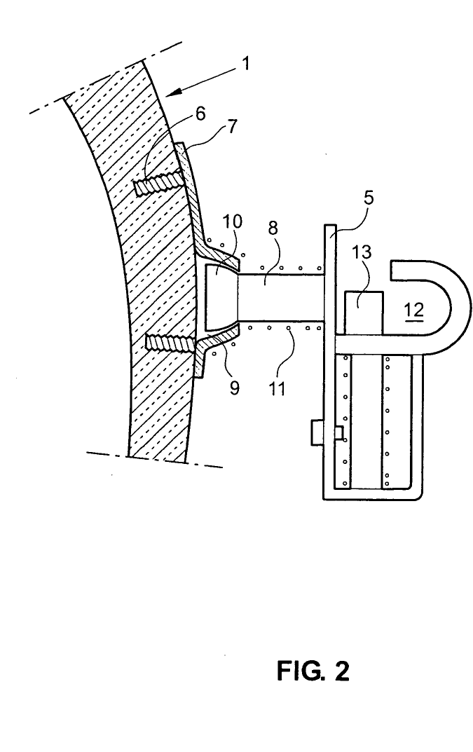

FIG. 2 is a sectional view of the hitch device illustrated in FIG. 1.

Referring to FIG. 1, therein is shown a driving harness 1 according to the invention. The harness is mounted on the horseback and secured thereon with the help of straps 2 attached to the harness. Advantageously, the harness is shaped so that it cannot be strapped too much behind on the center of the horse's back, but instead, the harness aligns automatically on the right location where it does not press the withers, muscles adhering to the horse's neck at the withers or the long spinal muscles against the spinous processes of the horse's vertebral column.

The harness is generally provided with eye rings 3 through which the reins are passed. Additionally, the harness includes a hook member 4 whereto can be attached the overcheck which is a leather band having its one end attached to a curb bit placed in the horse's mouth or to a throat latch passed under the horse's jaws. The purpose of the overcheck is to control the position of the horse's head during the trot (of a trotter). The hook member 4 further includes a mounting lug for attaching a crupper. The crupper is a strap made of, e.g., leather with one of the strap passed about the dock. The crupper serves to keep the harness in place.

On both flanks of the horse, the harness 1 is provided with hitch devices 5, typically implemented as so-called quick hitches, to which the shafts of the pullable vehicle such as a sulky are connected in a detachable fashion. Onto the harness is mounted, e.g., using screws 6, a mounting plate 7 of the hitch device 5. The hitch device includes a mounting pin 8 by means of which the hitch device 5 is connected to the mounting plate 7 and, thereby, to the harness 1. The joint between the mounting pin 8 and the mounting plate is a so-called ball joint that facilitates free hitch device rotation relative to the harness within the constraints of the ball joint.

In FIG. 2 is shown the above-mentioned ball joint in a sectional view. As is illustrated in FIG. 2, the mounting plate 7 includes a cavity 9 with an interior surface of semi-hemispherical shape, wherein is adapted a ball end 10 of an essentially compatible spherical shape machined or attached to the end of the mounting pin 8 of the hitch device 5. Resultingly, the ball end 10 can rotate in the cavity freely in all directions within given limits set in a desired fashion. About the mounting pin 8 of the hitch device 5 is adapted a coiled spring 11 extending from the hitch device to the mounting plate 7 so as to stiffeningly pretension the ball joint.

As to its connecting function, the hitch device 5 is a conventional quick hitch with a coupling hook 12 wherein a compatible coupler member of the sulky shaft can be locked. The springedly moving locking pin 13 of the quick hitch is depressed when the shaft coupler member is pushed into the quick hitch coupling hook. As the shaft coupler member is fully home in the coupling hook 12, the locking pin springedly rises up thus locking the shaft coupler member into the hitch device coupling hook.

To those versed in the art, it is obvious that the invention is not limited by the above-discussed embodiments, but rather, may be varied without departing from the spirit of the appended claims. As known in the art, the ball joint between the harness and the hitch device can be realized in a plurality of different manners. The hitch device of the above-described type represents only one possible implementation. The hitch device need not be a quick hitch shown in the diagrams, but instead, any other type of hitch device may be used. The novel concept disclosed in the invention concerns a ball joint adapted between the hitch device and the harness. Hereby, the connection between the mounting plate 7 and the harness can be accomplished using other means than screws 6. Advantageously, the attached ends of the harness breast straps are buried in the interior of the harness so that the underside surface of the breaststrap and the underside surface of the harness saddle are aligned substantially in the same plane. Resultingly, the lower edge of the harness saddle will not deform into a projection that depresses the horse, but instead the harness conforms smoothly to the horse's body.

1. A horse driving harness (1) for attaching a pullable implement such as a sulky, the harness being mountable on a horse's back and securable thereto with the help of suitable straps (2) and the driving harness incorporating a hitch device (5) adapted on the sides of the harness facing both flanks of the horse for hitching the sulky shafts to the harness, characterized in that the mounting of the hitch device (5) to the harness (1) is implemented with the help of a ball joint, whereby the hitch device is freely rotatable relative to the harness within the constraints of the ball joint.

2. The harness of claim 1, characterized in that to the harness (1) is attached a mounting plate (7) having its interior surface formed into a semi-hemispherical cavity (9), wherein is adapted a ball end (10) of an essentially compatible spherical shape machined or attached to one end of the mounting pin (8) of the hitch device.

3. The harness of claim 1, characterized in that about said mounting pin (8) of said hitch device (5) is adapted a coiled spring (11) extending from said hitch device to said mounting plate (7) so as to stiffeningly pretension said ball joint.

4. The harness of claim 1, characterized in that said straps (2) are attached in a buried fashion in the interior of the harness body so that the underside surface of said strap and the underside surface of the harness body are aligned substantially in the same plane.

5. The harness of claim 2, characterized in that about said mounting pin (8) of said hitch device (5) is adapted a coiled spring (11) extending from said hitch device to said mounting plate (7) so as to stiffeningly pretension said ball joint.

6. The harness of claim 2, characterized in that said straps (2) are attached in a buried fashion in the interior of the harness body so that the underside surface of said strap and the underside surface of the harness body are aligned substantially in the same plane.

7. The harness of claim 3, characterized in that said straps (2) are attached in a buried fashion in the interior of the harness body so that the underside surface of said strap and the underside surface of the harness body are aligned substantially in the same plane.

8. The harness of claim 5, characterized in that said straps (2) are attached in a buried fashion in the interior of the harness body so that the underside surface of said strap and the underside surface of the harness body are aligned substantially in the same plane.
